(19) United States
(12) Patent Application Publication
(10) Pub. No.: US 2013/0298814 A1
(43) Pub. Date: Nov. 14, 2013

(54) Method for Treating Wood and Wood-Based Materials, and Wood and Wood-Based Materials Obtainable Therewith

(71) Applicants: Holger Militz, Bovenden (DE); Karl-Christian Mahnert, Goettingen (DE); Frank Luessen, Lemwerder (DE)

(72) Inventors: Holger Militz, Bovenden (DE); Karl-Christian Mahnert, Goettingen (DE); Frank Luessen, Lemwerder (DE)

(21) Appl. No.: 13/884,287

(22) PCT Filed: Nov. 10, 2011
(86) PCT No.: PCT/EP2011/069843

§ 371 Date: Jul. 18, 2013

(30) Foreign Application Priority Data
Nov. 10, 2010 (DE) 10 2010 050 788.1

(51) Int. Cl. B27K 3/15; B63B 3/48; B27K 3/34

(52) U.S. Cl. CPC B27K 3/15; B27K 3/34; B63B 3/48
USPC 114/85; 428/541; 427/335; 427/297

(57) ABSTRACT

The present application relates to a method for treating wood and wood-based materials for enhancing dimensional stability and surface properties and also for preventing cracking and extending durability. More specifically the invention for the treatment of wood and wood-based materials is directed to a method wherein the wood or wood-based material is subjected to a thermal treatment and the wood or wood-based material is at least partly impregnated with a melamine-containing resin. Subsequently the wood or wood-based material thus impregnated is cured with hot steam at not more than 125° C. preferably up to a maximum of 120° C. In a further aspect the present application includes the thermally treated wood or wood-based material, impregnated with melamine resin and cured, that is obtainable from the method of the invention. The present invention lastly provides for the use of melamine-containing resin for impregnating wood and wood-based materials which are or have been thermally modified, for the purpose of increasing the hardness and reducing the dimensional change through thermal modification. The material produced in accordance with the invention can be used as a substitute for teak.

The present application relates to a method for treating wood and wood-based materials for enhancing dimensional stability and face properties and also for preventing cracking and extending the natural durability and also optical alteration. More specifically the invention for the treatment of wood and wood-based materials is directed to a method wherein the wood or wood-based material is subjected to a thermal treatment and at least partly impregnated with a melamine-containing resin. The wood or wood-based material thus impregnated is cured in a hot steam atmosphere at not more than 150° C., such as not more than 120° C. In a further aspect the present application includes the thermally treated wood or wood-based material, impregnated with melamine resin and cured, that is obtainable from the method of the invention. The present invention lastly provides for the use of melamine-containing resin for impregnating wood and wood-based materials which are or have been thermally modified, for the purpose of increasing the hardness and reducing the dimensional change through thermal modification, more particularly, among others, as a teak substitute.

### PRIOR ART

By wood modification are meant all measures that lead to a biocide-free improvement in the wood properties. The properties improved include, for example, the dimensional stability under fluctuating humidity, and durability with respect to wood-destroying fungi.

A large number of wood enhancement methods are already in existence, such as, for example, heat treatment methods, acetylization, furfurylation, synthetic resin impregnation, hydrophobizing with vegetable oils, and silicification and/or silylation.

Distinctions are generally made between the following approaches to wood modification: During the thermal modification of wood, lumber is heated in an inert atmosphere of water vapor or nitrogen, in vegetable oil as well in certain processes, to temperatures between 160° C. and 280° C.

Hydrophobization with oils, waxes, and paraffins is based on the filling of the cell cavities with the stated substances through impregnation of the wood. Depending on the melting point of the substances used, the treatment must be carried out in a heated impregnating vessel.

For the chemical modification of the wood cell wall, reactive chemicals are employed such as acetic anhydride (Accoya® process) or dimethylo-dihydroxy-ethylene-urea (Belmadur® process). In some cases these chemicals are admixed with catalysts, impregnated into the wood, and then reacted to completion at temperatures of around 100° C. In the course of such treatment, as well as the crosslinking of the cell wall polymers (wood crosslinking), there is also binding of the chemicals to functional groups of the cell wall polymers.

For the polymerization of chemicals in the cell wail, mention may be made, firstly, of synthetic resins (e,g., phenol- and melamine-formaldehyde resins). Secondly, furfuryl alcohol may be mentioned as a further chemical, being obtained from biomass. This process is operated industrially by KEBOY Asa in Norway. In the case of the treatment of wood with silicon compounds, a variety of classes of substance are employed, including waterglasses, silanes, and silicones.

A thermal treatment of wood is employed for the purpose among others of killing pests or else of altering the wood substance and, consequently, enhancing the resistance toward wood-destroying organisms and other environmental influences. This thermal treatment of the wood may take place hydrothermally, in oil, under a nitrogen atmosphere, or in accordance with the heat treatment approaches or methods stated in the description of the invention. The aim of the heat treatment is to increase the durability of the wood, to reduce the hygroscopicity, and to improve the wood's dimensional stability.

Thermal wood modification is well established. Among others, thermal enhancement of wood is carried out according to processes from Thermowood, StoraEnso, Stellac Wood, le Bois Rétlfié or Plato. Typically in these cases the wood is treated in the absence of oxygen for 24 to 48 hours at a temperature of 180° C. to 230° C. The wood thus thermally enhanced exhibits low swelling and contraction behavior, and the intensity of the loss of mass through the attack of wood-degrading fungi is reduced. Nevertheless, such thermally enhanced woods are frequently characterized in that they have a characteristic burn odor, reduced mechanical strengths, especially reduced surface hardness and increased cracking, brittleness, and also a strong discoloration.

A short while ago, Sernek M., et al., in Holz Roh Werkst., 2008, 66, 173-180, investigated the adhesive bonding performance of heat-treated wood. In those investigations, hydrothermally treated and heat-treated wood were bonded using various adhesives, in order to examine the effect of the heat treatment on the bonding performance. It was found that the shear strength and the delamination of the glued laminated board was dependent on the adhesive used,

In WO 02081159, amines are used for the wood treatment. They are applied at low concentrations prior to the heat treatment, in order to control pests within the wood. In other words, the amines described therein are used as biocides and have no influence on the strengths of the treated material.

A short while ago, in WO 2008/155466, a method was described for the surface treatment of thermally modified wood. In that case an attempt was made to improve the surface properties of the thermally modified wood by melamine treatment. To that end, the wood, heat-treated in accordance with the typical process, was coated in a subsequent step with a protectant based on liquid resin, and was dried and cured to give a transparent protective surface of thermoset material. Coating of the thermally modified wood with a melamine resin is among the embodiments described. For that purpose, said melamine resin is applied to the thermally treated wood and cured at temperatures of 130° C. to 160° C., after drying of the wood by evaporation of the water. Here, in some cases, catalysts are used as well, to improve the curing. Nevertheless, the method described therein has disadvantages, such as a high energy demand, for example. Furthermore, toxic substances are released from the wood or wood-based material, such as methanol and formaldehyde, for example, and also other volatile organic compounds (VOCs). There is also a high risk of inflammation and/or explosion from released gases during the process. Moreover, this publication envisages essentially a coating process for obtaining a transparent protective surface of thermoset material. Improving the properties over the entire cross section of the material, therefore, cannot be achieved.

Known from EP 1 937 448 is a wood treatment method in which low-formaldehyde lignocellulosic material is produced. A feature of this method is that the lignocellulosic material is impregnated with an aqueous composition comprising at least one crosslinkable nitrogen compound and at least one substance that catalyzes the crosslinking. The material thus impregnated is subsequently treated with superheated steam and with at least one subsequent treatment at a temperature above 110° C. at a relative moisture content of the gaseous medium surrounding the lignocellulosic material of not more than 20%, In this case, 1,3-bis(hydroxymethyl)-4,5-dihydroxyimidazolidinion-2-one (DMDHEU) is used, with or without addition of melamine resin. The DMDHEU is polymerized with addition of catalysts, without which this polymerization of the DMDHEU is not possible. The subsequent dry treatment takes place at 130° C. It is further stated that effect substances, such as colorants, for example, can also be added to modify the wood, in order to obtain desired properties in the product.

Some of the processes identified above have already been used to modify alternative types of wood in such a way that they can be used as decking. Maple, for example, is endowed by furfurylation with similarity in many qualities to teak, and yet the product, visually, is distinctly different from teak. Furthermore, experiments have also been conducted with thermally modified ash, which in visual terms is much more similar to teak than the aforementioned furfurylated material. Moreover, it possesses many positive technical properties (hardness, abrasion resistance, weathering stability), but teak is superior in respect of its natural durability. All of the existing alternatives to a teak deck have severe adverse differences. Accordingly, ₜhe requirements imposed on a product for application in The high-price target market segment are not fulfilled, and the alternative materials are not utilized.

The decking of a boat is required to satisfy a very wide variety of requirements, of technical and aesthetic kind. In the case of passenger boats and yachts, the visual criteria are particularly important, besides the technical properties, in the passenger or owner and guest areas. In the external areas, therefore, wood is preferably employed. Examples of woods commonly used include kambala, Oregon pine, and teak, and teak may be regarded as the classic material, having outstanding properties inter alia in terms of dimensional stability, natural durability, crack resistance, hardness and weathering resistance. Furthermore, the growth pattern is very attractive, since long, knot-free planks with regular annual rings can be cut from one trunk.

The natural incidence of teak is confined to the countries India, Indonesia, Thailand, and Myanmar (Burma), where the three first-mentioned states exploit their teak stock for themselves, with no wood entering the export trade. Only Myanmar is to date still exporting teak that meets the requirements for the decking of yachts and boats. However, the trade embargo imposed by the EU against Myanmar in Fall 2007 cut off the yacht and boat industry from this resource. From the present-day standpoint, the long-term supply of teak is not adequately ensured. In order to be able in the future to provide decking of sufficient quality, the need exists to find an alternative material. Plantation teak fails in technical and visual terms to satisfy the requirements for a high-grade decking, since the rapidity of its growth results in unfavorable visual appearance and in a broad fluctuation in mechanical and other properties, such as natural durability, for example.

In order to be able to continue offering high-quality decking despite the scarcity of natural teak, a variety of materials have been trialed, and developments undertaken, in the past. On the one hand, synthetic floor coverings have been developed, and on the other hand alternative woods have been subjected to modifying processes with the aim of positively influencing the properties of the wood used. In some cases, technically speaking, known synthetic floor coverings are very good alternatives to teak. In sectors with very exacting requirements on appearance and esthetics, however, they cannot represent any wholesale substitute for a teak deck.

There is therefore a need to provide methods which an improvement in the physical and chemical properties of thermally treated wood, more particularly an improvement in the dimensional stability and strength of the wood in conjunction with improved surface hardness. One important aspect here is the prevention of release of toxic substances, such as formaldehyde or other VOCs (volatile organic compounds), to the environment, not only during the production procedure or else during the, utilization of the treated wood or wood-based material. Furthermore, the method shall alter the visual properties of the wood or wood-based material positively in the sense of the future utilization, making them more like those of teak, for example.

### DESCRIPTION OF THE INVENTION

In accordance with the invention, this object is achieved through the method according to claim 1 and through the treated woods and wood-based materials obtainable by said method, in accordance with claim 12.

It has been possible, surprisingly, to show that, using the method of the invention, a reduction in energy use, controlled release of toxic substances, and an improvement in the strength and surface hardness, but also in the optical properties, have been achievable. In a first aspect, the present invention is directed to a method for treating wood and wood-based materials, by subjecting the wood or wood-based material to a thermal modification, characterized in that the wood or wood-based material is at least partly impregnated with a melamine-containing resin and subsequently the wood or wood-based material thus treated is cured with hot steam at up to 150° C., in the range from 80 to 150° C., for example, under atmospheric pressure. Curing takes place preferably at 80-120° C., as for example 90-120° C., more particularly 110° C.-120° C. With further preference the temperature is below 120° C. The wood thus treated showed improved strengths and surface hardnesses and also good dimensional stability.

Unless stated otherwise, the expressions “encompass”, “encompassing”, “comprise” or “comprising” also cover the embodiments of “consist” or “consisting”.

It has been found, surprisingly, that the step of curing the melamine-containing resin with hot steam at up to 150° C., more particularly not more than 120° C., permits a reduction in energy costs in comparison to other methods of wood modification. At the same time it is possible to bind volatile toxic compounds, such as formaldehyde, for example, by means of the hot steam, and so to prevent any uncontrolled release. The wood thus treated exhibited improved strengths and surface hardnesses and also good dimensional stability and weathering resistance, and also a heightened, natural durability.

The expression “thermal modification” of wood describes a process of wood modification in which wood, depending on the various processes, is heated preferably with substantial exclusion of oxygen at temperatures between 150° C. and 280° C., and, under temperature exposure, the wood is altered in such a way that key properties are modified, such as dimensional stability and color, for example. The chemical and physical processes that this entails result in the following changes:
reduced water absorption
reduced equilibrium moisture content
enhanced durability toward wood-destroying organisms
improved dimensional stability
decrease in density
reduction in density-correlated strengths
visual alteration, more particularly darkening

The substantial or complete absence of oxygen during the thermal treatment of wood is achieved, depending on the method, by treating the wood in water or steam (hydrothermal modification), a nitrogen atmosphere, or through presence of other inert gases or substances.

In accordance with the method of the invention, in one preferred embodiment, the wood material in one step, atypically, is subjected to a heat treatment, in order primarily to modify the appearance and the dimensional stability of the wood and to influence these qualities positively, whereas in the prior art a heat treatment is used primarily in order to influence technical properties—mechanical properties, for example—of a workpiece. The heat treatment of the invention takes place preferably with exclusion of oxygen. With regard to the wood, the heat treatment results in a modified color, more particularly in a darkening of the wood. The heat treatment is carried out for the purpose of ideal coloration, causing the wood to darken completely and uniformly, thus giving the wood, for example, a teaklike appearance. Complete coloring right through is particularly preferred, since in particular the decking of a boat will be sanded down a number of times over the course of time, and an irregular or partial coloring will entail unattractive spotting. Furthermore, the microporosity of the wood is altered in such a way as to allow greater absorption of the melamine-containing resin during the impregnation.

For the term “thermal modification”, the following synonyms are used, with no claim of completeness of the list: thermal enhancement, heat treatment, heat modification, thermal modification, thermophysical modification, thermal up-grading, and heat treatment.

Known processes are described by the following companies: Stellac, Bois Rétifié, Stellac, MITT, Plato, OHT, OpelTherm, BICOS, FirmoLin, NewOptionWood.

The expression “hot steam” refers in the present context to saturation of the atmosphere of the reaction environment with water vapor. The temperature of the water vapor is in particular not more than 120° C., such as less than 120° C., and is preferably 100-120° C.

The expression “wood” refers in the present context to the perennial tissue, composed of different cells, of softwoods and hardwoods. The material harvested as roundwood is processed further to form, for example, lumber (planks or boards), which can then be used in accordance with the invention.

The expression “wood-based material” refers in the present context to a composite material comprising wood particles, such as chips, fibers or strands. Wood-based materials are more particularly those including plywoods, laminated woods, and glued woods, wood chipboard and wood fiberboard.

The expression “melamine-containing resins” refers to those resins which have melamine(2,4,6-triaminotriazine) as one component. More particularly these are MF resins (melamine-formaldehyde resins). They are obtained by the polycondensation of melamine with formaldehyde. Other melamine-containing resins, including melamine resins, include the following: melamine-formaldehyde resins (MF resins), melamine-urea-formaldehyde resin (MUF); melamine-urea-phenol-formaldehyde resins (MUPF), or methanol-etherified melamine-formaldehyde resin, methanol-etherified MUF, or methanol-etherified MUPF.

The cured resin is a colorless, chemical-resistant and temperature-stable thermoplastic.

In accordance with the invention it has emerged that when hot steam is used, the volatile toxic constituents remain in this hot steam and are separated from the hot steam in a downstream processing step, so that no uncontrolled release of any partly toxic volatile constituents such as formaldehyde or methanol takes place into the environment.

The hot steam process is carried out in an autoclave, for example. In a manner similar to that in the case of Esteves et al. (2007) Wood Science and Technology 41(3), 200193-207, the autoclave vessel is filled with the hot steam from outside, via a line, during the procedure. The procedure can be carried out, for example, in a high-temperature wood dryer, in accordance with the invention. The skilled person is aware of suitable methods and apparatus for such procedures.

The curing of the melamine-containing resin in the tissue structure of the wood, as described, produces a three-dimensional framework of high molecular mass that re-inforces the wood structure and thus leads to an increase in the mechanical robustness, especially the hardness. At the same time, the points for attack by wood-destroying microorganisms such as fungi are physically blocked, and an enhanced durability toward biological degradation is therefore obtained.

Through the combination of the two modifications identified above, moreover, a degree of weathering stability matching that of teak is ensured, for example. A particular advantage here is that the wood is colored throughout its entire volume in the case of a heat, treatment method. Consequently, working operations such as sanding, sawing, etc. are possible without visual detraction. A disadvantage, however, is a reduction in the strength properties as a consequence of the thermal treatment. In the further method step, this reduction in the strength properties is compensated by means of impregnation with melamine-containing resin. The entire wood is impregnated, advantageously, in this procedure. The impregnating agent is used preferably in an aqueous solution with a concentration in a range of 5%, 10%, 15%, 20%, 25%, 30%, 35%, 40%. Melamine resin is used with particular preference for the impregnation. Melamine resin here encompasses, more particularly, melamine, melamine-formaldehyde resin, melamine-formaldehyde resin-containing stock solution, and the like. Other polymerizable chemicals as well may be used in accordance with the invention. After the wood-based material has been impregnated with the melamine-containing resin, it is cured. In the course of curing, the melamine-containing resin undergoes polymerization and forms a solid structure. This results in a substantially increased durability of the wood. The hardness of the wood goes up as well. A particular advantage is the colorless nature of the melamine resin, meaning that the coloration of the wood-based material as set by means of the heat treatment is retained.

In one preferred development of the method of the invention, the heat treatment comprises at least the step of a high-temperature vacuum treatment. A heat treatment step of this kind is preferred since in a heat treatment chamber there is no need to introduce any other inert medium. The oven or autoclave is evacuated, and gases emerging from the wood can be drawn off under suction.

In accordance with a further preferred embodiment of the method of the invention, the impregnation takes place in a vacuum pressure process. In accordance with another preferred embodiment of the method, the vacuum pressure impregnation encompasses a preliminary vacuum phase. In the vacuum phase, gas present in the wood is removed, resulting in a consequent increase in the impregnability of the wood-based material. In this way a greater loading of the wood-based material with treatment agent can be achieved, thereby further positively influencing the mechanical properties of the treated wood.

In accordance with a further preferred embodiment of the method, the vacuum pressure impregnation encompasses a high-pressure phase. In such a high-pressure phase, the wood or the wood-based material and the treatment agent are subjected to a high pressure, such as 8 to 14 bar, for example. In this way, depending on the temporal duration of the application of pressure, high loading of the wood-based material, and uniform and complete impregnation, are achieved. This provides the best preconditions for uniform improvement in the mechanical properties of the wood-based material.

In the course of the vacuum pressure impregnation, the cell cavities are filled with the impregnating solution.

In accordance with a further preferred embodiment of the method, the melamine resin is cured as part of a hot steam drying operation. By exposing the wood-based material to a specific hot steam atmosphere during the drying procedure, it is possible to regulate the degree of moisture in the wood-based material. Since the melamine-containing resin at the beginning of the drying procedure is essentially in a liquid state within the wood-based material, the heat-catalyzed curing is accompanied by release of volatile constituents. In accordance with a further preferred embodiment of the method, the step of curing encompasses a step of polycondensation of the melamine-containing resin, more particularly of the melamine resin.

In accordance with a further preferred embodiment of the method, it includes a step of moisture conditioning of the wood-based material. The moisture conditioning is preferably to be performed following the curing of the melamine-containing resin. A moisture conditioning procedure allows the mechanical properties of the wood-based material to be further positively influenced.

In a further preferred embodiment, the curing of the melamine-containing resin with hot steam at not more than 120° C., more particularly less than 120° C., is followed by the thermal modification of the wood or wood-based material. This treatment of the wood or wood-based material takes place immediately thereafter, without prior cooling of the wood or wood-based material to below 50° C., such as not below 80° C. After the hot steam treatment at not more than 120° C., the wood or wood-based material is preferably not cooled down again. Instead, the thermal treatment of the wood follows immediately, in the form, for example, of a thermal enhancement at 150-280° C. in one of the known processes. Mention may be made at this point, by way of example, of two of the established processes: the hydrothermal Plato process, in which a treatment takes place in a water vapor atmosphere. The temperature in this case is set at 180° C. to 240° C.; the duration is 24 to 48 hours, but may also be shortened to 4 to 24 hours, such as 6 hours. In a process referred to as retification, the wood is treated in a nitrogen atmosphere for 0.5 to 4 hours at temperatures of 160° C. to 250° C.

In a further preferred embodiment, the method for treating wood and wood-based materials is one in which the wood, prior to treatment with the melamine-containing resin, has been modified thermally at temperatures of 150° C. to 280° C., such as 160° C.-260° C., especially preferably of 180° C. to 240° C. This thermally treated wood is impregnated with melamine-containing resin and subsequently cured under hot steam conditions at not more than 150° C., preferably up to a maximum of 120° C., such as below 120° C.

The method of the invention in this case is preferably accomplished by impregnating the wood or wood-based material completely with the melamine-containing resin. That is, the impregnation with the melamine-containing resin takes place preferably in such a way that there is complete impregnation right through the wood or wood-based material. The impregnating step is performed, accordingly, for a sufficiently long time to achieve full impregnation of the wood or wood-based material. This impregnation of the wood or wood-based material takes place in accordance with known processes, such as a vacuum pressure process, for example.

In another preferred embodiment, the solution with melamine-containing resin, for impregnating the wood or wood-based material, is a solution which contains at least no catalysts, coloring substances or substances relevant to fire protection as adjuvants. In conformation to the intended use or area of deployment of the product, however, the addition of plasticizing and/or hydrophobizing additives is possible and may be preferred.

The method of the invention is suitable for all impregnable wood types such as pine, Weymouth pine, alder, birch, maple, beech, hornbeam, willow, poplar, Hevea and Bombax species, chestnut ceiba, ramin, sesendok, llomba, kondroti, eucalyptus, limba, coto, or wood-based materials comprising these materials, more particularly limba (Terminalia superba) or koto (Pterygota ssp.).

In accordance with the invention it is possible to improve the properties of low-grade wood, including, in particular, domestic softwood, by the method of the invention. This therefore permits it to be used in the outdoor sector, as for example for patios, or in the construction industry, or else in the floor or wet sector, where requirements in terms of hardness and dimensional stability are more exacting. The method of the invention, specifically a simultaneous thermal treatment of the wood with impregnation with melamine resin and with curing immediately thereafter under a hot steam atmosphere, and also treatment of thermally modified wood with melamine-containing resin and curing with hot steam, makes it possible to reduce the loss of strength by wood as a consequence of the thermal modification.

The method of the invention is also particularly suitable for nontropical wood types such as pine, Weymouth pine, alder, birch, maple, beech, hornbeam, willow, poplar, chestnut, or wood-based materials comprising these materials.

The method of the invention is therefore suitable for all hardwood and also, in particular, softwood varieties, provided they are impregnable.

These woods and wood-based materials thus treated can be employed more particularly in the following areas: in outdoor lining and earthwork lining, in gardening and landscaping, in sheet piling and noise protection walls, as railroad ties, for the building of bridges and jetties, and other harbor areas. Suitable fields of application further include patio boards in areas with earth contact, architectural facing components, windows and doors, and playground installations. The wood modified in accordance with the invention may additionally be used as material for boatbuilding and as weathering-resistant decking, and also for the production of furniture for the interior and exterior segments. Another field of application is in packaging materials.

As a result of the treatment with melamine-containing resin, more high-grade wooden and wood-based material products can be provided. More particularly it is possible to provide woods and wood-based materials which exhibit improved surface hardness, strength, and dimensional stability as compared with thermally treated wood which has not been impregnated with melamine, in accordance with the invention, and subsequently cured with hot steam.

Through complete impregnation of the wood or wood-based material it is possible to improve the contraction behavior of the thermally modified woods and wood-based materials thus treated. Furthermore, the methods of the invention allow improvements in the optical properties of the wood or wood-based material specific to the application, and the supply, for example, of a teak substitute.

Correspondingly, in a further aspect, the present invention is directed to thermally treated wood or wood-based materials, impregnated with melamine resin and cured, obtainable in accordance with one of the methods of the invention. These thermally treated woods impregnated with melamine resin and cured are distinguished by improved surface hardness and increased strength. At the same time, they display an improvement in dimensional stability and a reduced swelling or contraction behavior in comparison with thermally treated wood which has not been treated with melamine resin in accordance with the invention.

Preferential results are achieved in particular for the wood varieties of limba or coto by a method having the features identified above. These wood types are suitable on the basis both of their structure and impregnability and of the assured availability. Following application of the method of the invention, both the appearance and the technical properties are similar to those of teak, and allow the substitution of teak.

In accordance with a further aspect of the invention, the object is achieved, in the case of a boat of the type specified at the outset, by the decking being formed from wooden elements having features of the wooden element specified above. A wooden element of the invention of this kind possesses properties similar to those of teak. On the deck of a boat, the wood is exposed to severe stresses, such as weathering, salt water, foot traffic, cleaning agents, and the like. Wooden elements having the properties specified above are treated by means of a method having the features identified above, and the technical properties, consequently, resemble those of teak. The wooden element of the invention withstands the stated stresses and in accordance with the invention is suitable as decking on boats and/or yachts. The modified wood can also be used for further applications on boats and yachts. A further preferred field of application is that of handrails.

In accordance with a further aspect of the invention, the object, when using treated wood as a substitute for teak, is achieved by the wood being treated by a method having the above-identified features of a method of the invention. On the basis of the visual and technical properties, this treated wood is particularly suitable as a teak substitute. It is preferred more particularly to use limba or coto as starting material. The wood or the wood-based material may in this case consist of one of the aforementioned wood types.

In other words, an aspect of the present invention is a method in which wood or wood-based materials are impregnated with an aqueous solution comprising melamine-containing resin, such as melamine-formaldehyde resin, preferably without catalyst, coloring substances, or substances relevant to fire protection, this impregnation more particularly being complete impregnation, and the resin being cured in hot steam at not more than 150° C., such as not more than 120° C., more particularly less than 120° C., in a procedure combined with the thermal modification. The curing phase of the melamine-containing resin in this case, at up to 150° C., preferably up to 120° C., such as below 120° C., in the hot steam is followed by a thermal modification of the wood with temperatures of 150° C. to 280° C., such as 160° C.-260° C., especially preferably 180° C. to 240° C.

The method of the invention takes place preferably with impregnation by melamine-containing resin, the curing of this melamine-containing resin, and the subsequent thermal modification of the wood or wood-based material in a continuous procedure, in an installation suitable accordingly.

A further aspect of the present invention is a method for treating thermally modified wood, where this thermally modified wood is impregnated by an aqueous solution of a melamine-containing resin. This impregnating solution preferably comprises no catalyst and no coloring substances or substances relevant to fire protection. Impregnation of the thermally modified wood is followed by curing of the resin under hot steam conditions' at not more than 150° C., such as not more than 120° C.

The invention is described in more detail below by means of exemplary embodiments, with reference to the drawings. In the drawings

FIG. 1 shows the procedural flow diagram of one embodiment of a method of the invention.

The schematic course as shown in FIG. 1 of one embodiment of the method of the invention has five steps, with only three steps forming part of the actual method. First of all, in a first step 1, the wood to be treated is selected. Here, depending on the requirement, assessments are made of visual defects and structural wood features such as grain, knots, reaction wood, etc. In the context of wood treatment, a single batch should be assembled exclusively from wood with the same dimensions and impregnability, with account being taken of the criteria identified above.

In the heat treatment, the wood is treated thermally at a temperature, for example, of between about 160 and 220° C., depending on the wood variety and on the coloring to be achieved. This step preferably takes place in the absence of oxygen, with further preference in a vacuum atmosphere.

After an intermediate cooling phase of the wood material (not shown), the heat treatment, T according to this exemplary embodiment, is followed by the impregnation I, preferably with melamine resin. Impregnation I encompasses a vacuum pressure impregnation with aqueous resin solution in a standard commercial vacuum pressure impregnating system. After the and of the vacuum phase, pressure impregnation takes place preferably at pressures of between 8 and 14 bar, with the time design of the pressure course and also the overall time duration being dependent on the dimensions of the wooden pieces and also on the type of wood used. During this impregnation, the cellular spaces within the wood become filled with the impregnating solution.

The resin impregnating step I is followed by the curing step A. In this step, the thermocatalytic polycondensation reaction of the resin is triggered by supply of heat. The synthetic resin undergoes condensation to form long-chain polymers, with the consequent formation of a three-dimensional network. At this stage, in addition, the melamine reacts chemically with the cell walls, thereby further positively influencing the durability and also the technical properties. The byproducts that are released in the course of the polycondensation are removed by the hot steam in the hot steam atmosphere. The hot steam atmosphere may also be used, additionally, to perform moisture conditioning of the material. The duration of the curing step is again dependent on the melamine loading, the material, and the geometries and dimensions of the materials.

Removal from the reaction tank reveals a completed material 2. This material can then be worked in general like a conventional wood-based material. The visual and mechanical properties of such a material are substantially the same as those of teak, given suitable intensity of treatment and suitable procedural regime. The wood thus treated can be used as decking and handrails on boats and yachts, or generally as a teak substitute.

The invention is elucidated below by means of examples, without being confined to these examples.

### EXAMPLE 1

Surface hardness

For the combination treatment comprising MF resin modification and thermal modification of wood in one process step, sapwood of the pine (Pinus sylvestris) was used as starting material.

The composition of the melamine solutions consisted of 25% Madurit MW 840/75WA (INEOS MELAMINES GmbH) with a solids content of 75%. The solution was also stabilized with 0.2% to 5% triethanol, and the pH was adjusted, using 5% strength NaOH, to 8 to 12, preferably 9 to 11.

18 test specimens (25×25×25 mm³) were impregnated with the 25% MF resin solution. For reference investigations, 18 test specimens were impregnated with water.

The wood was impregnated in a vacuum pressure process as used in the wood industry. The following figures for the treatment pressures selected are based in each case on a standard pressure of 1.013 bar. The preliminary vacuum was 0.1 to 0.9 bar for 0.1 to 4 hours, preferably 0.5 to 1.5 hours. The pressure impregnation took place at 10 to 14 bar, preferably 12 to 13 bar, for 1.5 to 13 hours, preferably 2 to 8 hours. The subsequent vacuum at 0 to 0.5 bar was applied over a period of 0.2 to 5 hours, preferably over 0.3 to 1 hour.

The impregnated test specimens were cured in hot steam over a period of 6 hours in each case in a laboratory autoclave, or at room temperature (20° C.). In a first step, the melamine resin was cured in a hot steam atmosphere at 120° C., and the thermal modification of the wood, which follows directly, took place at 180° C. and in a second phase of the procedure. In the case of the comparative sample there was no thermal treatment.

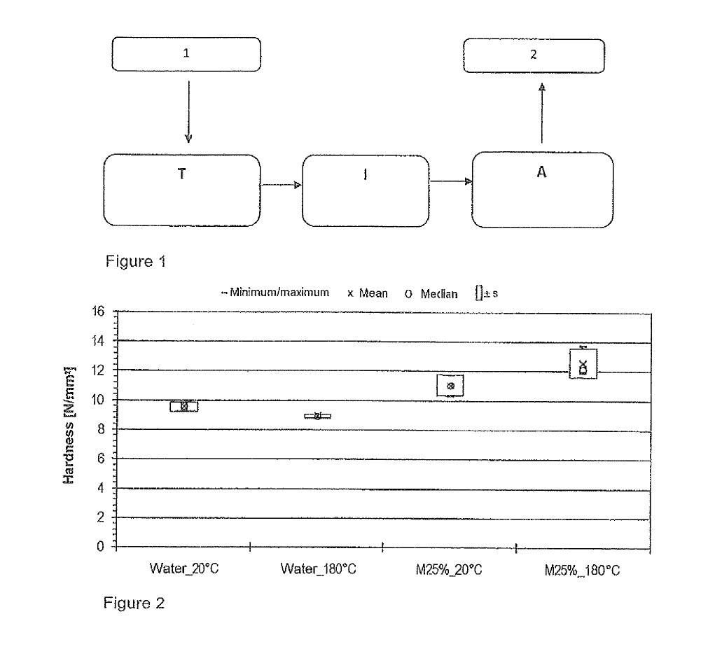

Following the subsequent acclimatization of the test specimens at 20° C. and 65% relative humidity, the surface hardness was determined in accordance with DIN EN 1534 (2010) on six test specimens per variant (FIG. 2).

The decrease in the hardness of the material as a result of the thermal modification of the wood without subsequent MF resin modification is visible, as is the distinct increase in hardness as a result of the additional MF resin treatment.

Breaking Load

Test specimens (10×10×180 mm³) were produced from pine sapwood for determining the maximum force on the wood at break. These test specimens were impregnated with a melamine solution consisting of 30% Madurit MW 840/75WA (INEOS MELAMINES GmbH) with a solids content of 75%. The solution was additionally stabilized with 0.2% to 5% triethanol, and the pH was adjusted, using 5% strength NaOH, to 8 to 12, preferably 9 to 11.

The wood was impregnated in a vacuum pressure process as documented in the Surface Hardness section.

The combined curing of the melamine resin and the thermal modification took place in a multistage procedure at a maximum temperature of 180° C., to which the test specimens were exposed over a period of 3 hours. The material produced is identified below as mtP (melamine-thermo-pine).

The mean percentage increase in mass of the test specimens as a result of the combination treatment was 34%.

As reference material, test specimens made from the same material without impregnation treatment were thermally modified over a period of 3 hours at 180° C. This material is identified as tP (thermo pine).

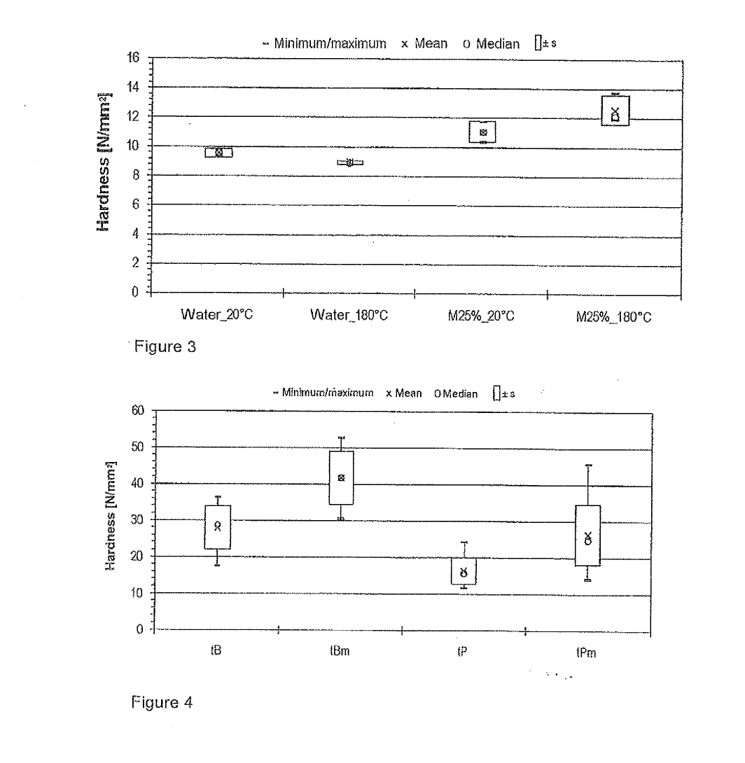

Investigation of the test specimens shows, surprisingly, a marked increase in the force at break for the samples which had been treated with melamine resin prior to the thermal treatment (FIG. 3).

### EXAMPLE 2

Starting material for the treatment is thermally modified beech (tB) and thermally modified pine (tP) from a commercial process. The treatment temperature was 210° C. in each case. The samples had dimensions of 160×25×1400 mm³, with the end faces being sealed with PYROTECT (RÜTGERS Organics GmbH). The samples for the following investigations were produced from the modified boards.

The MF resin used was Madurit MW 840/75WA (INEOS MELAMINES GmbH) with a solids content of 75%. The proportion of Madurit in the aqueous impregnating solution was 25%, with the further addition of 0.2% to 5% triethanol to stabilize the impregnating solution, and of 5% strength NaOH to adjust the pH of the solution to the 8 to 12, preferably 9 to 11, range.

The wood was impregnated in a vacuum pressure process. The following figures for the treatment pressures selected should be understood in each case in reference to a standard pressure of 1.013 bar. The preliminary vacuum was 0.1 to 0.9 bar for 0.1 to 4 hours, preferably 0.5 to 1.5 hours. The pressure impregnation took place at 10 to 14 bar, preferably 12 to 13 bar, for 1.5 to 13 hours, preferably 2 to 8 hours. The subsequent vacuum at 0 to 0.5 bar was applied for a period of 0.2 to 5 hours, preferably for 0.3 to 1 hour.

The wood was cured in hot steam at 120° C. The modified wood types are identified below as tBm (thermally modified beech+melamine resin) and tPm (thermally modified pine+melamine resin). The increase in mass in the test specimens as a result of the modification with MF resin was determined from the difference in the dry mass of test specimens before and after the modification. It amounted to a mean of 23% for tBm and 20% for tPm.

Test specimens (50×50×20 mm³) were subsequently produced from the boards and were conditioned to constant weight under standard conditions (according to DIN 50 014 (1985), 20° C. and 65% relative humidity).

The surface hardness of the material was tested in accordance with DIN EN 1534 (2010) on latest specimens per material, perpendicularly to the grain.

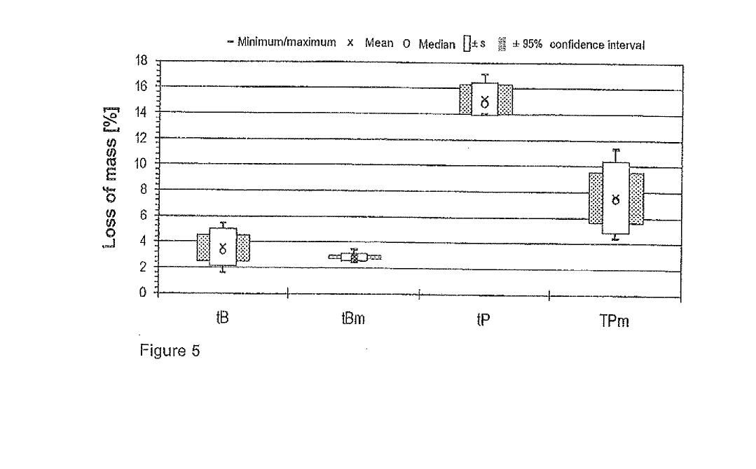

The increase in the Brinell hardness as a result of secondary melamine treatment of thermally modified wood is clearly apparent (FIG. 4).

Natural Durability

The natural durability of the tBm and tPm materials with respect to wood-destroying Basidiomycetes in comparison to the exclusively thermally modified wood types tB and tP was determined in a laboratory test along the lines of the standard CEN TS 15083-1 (2004).

For this test, defect-free test specimens with dimensions of 15×25×50 mm³ were subjected to aging in accordance with EN 84 (1997). The test specimens were subsequently installed into Kolle flasks with a poured lining of malt agar, the flasks having been inoculated beforehand with the test fungi Poria placenta (brown rot) and Trametes versicolor (white rot). Assignment of the investigated wood types to the durability classes is done using the results for the test fungus that caused the greatest loss of mass (LM). The median of the relevant LM is calculated and classification takes place on the basis of the values from table 1.

According to CEN TS 15083-1 (2004), the experiment is valid if the loss of mass of the untreated test specimens made from beech (in the case of Trametes versicolor) is at least 20%. This requirement is met, and the investigation satisfies the criteria of the standard.

Since the LM of the test specimens was greatest after attack by the white rot fungus Trametes versicolor, the values from the experiment with the stated test fungus are employed for the durability classification. A distinct improvement is apparent in the durabilities of the materials investigated, in each case from class 4 (low durability) to class 1 (highly durable); see table 2.

Accelerated Weathering

This investigation was carried out in the QUV instrument from the company Q-lab. The instrument serves for accelerated weathering by means of simulation of shortwave sunlight and rain exposure. The investigation was carried out along the lines of EN 927-6 (2006), a standard for the artificial accelerated weathering of coated surfaces. The weathering of 4 unsealed test specimens (18×74×150 mm³) per material took place over a duration of 4 weeks in one-week cycles in each case (table 3).

Assessment criteria employed are the graying of the test specimens, and also cracking. The graying, attributable to the exposed cellulose after UV-induced breakdown of the lignin and subsequent leaching, is equally developed in all of the materials.

Distinct differences become apparent, in contrast, in the cracking resulting from repeated cycling between moisture and drying:
tB: Development of end cracks from cycle 2
tBm: Minimal hairline cracks on the test specimen surface after cycle 4
tP: Increasing development of end and central cracks on test specimen surface at cycle 2
tPm: No cracking whatsoever

Therefore it was found that the stability of the wood against cracking as a result of weather effects was improved as a result of the treatment.

Abrasion Resistance

The capacity of the relevant materials to resist abrasion was determined in a method based on DIN EN 438-2 (2005) using the Taber Abraser. For this test, the acclimatized test specimens (100×100×5 mm³) were exposed at 70 rpm to 1000 revolutions of the test rollers furnished with sandpaper (100 grit). The abrasion resistance of a material was ascertained from the difference in mass in the acclimatized test specimens before and after the test. The higher the loss of mass, the lower the abrasion resistance of the material. The results are compiled in FIG. 5.

The melamine treatment leads to a reduced loss of mass and therefore to an increased abrasion resistance on the part of the treated wood types.

TABLE 1
Division into durability classes according to CEN TS 15038 (2004)

| Durability | | Loss of mass |
|---|---|---|
| class | Description | [%] |
| 1 | Highly durable | ≦5 |
| 2 | Durable | >5 to ≦10 |
| 3 | Moderate durability | >10 to ≦15 |
| 4 | Low durability | >15 to ≦30 |
| 5 | Not durable | >30 |

TABLE 2
Durability classification of the materials investigated:

| | Loss of mass | |
|---|---|---|
| Material | [%] | Durability class |
| Beech untreated | 26.6 | 4 |
| tB | 23.3 | 4 |
| tBm | 1.7 | 1 |
| tP | 23.0 | 4 |
| tPm | 1.0 | 1 |

TABLE 3
Composition of weathering cycle according to EN 927-6 (2006)

| Step | Function | Temperature | Duration |
|---|---|---|---|
| 1 | Condensation | 45 ± 3° C. | 24 h |
| 2 | Sub-cycle comprising | | 48 × 3 + 4 |
| | steps 3 + 4 | | |
| 3 | UV | 60 ± 3° C. | 2.5 h |
| 4 | Spraying | | 0.5 h |

1-16. (canceled)

17. A method for treating wood and wood-based materials, comprising the step of subjecting the wood or wood-based material to a thermal modification, whereby the wood or wood-based material is at least partly impregnated with a melamine-containing resin and subsequently the wood or wood-based material thus impregnated is cured in a hot steam atmosphere at not more than 150° C.

18. The method of claim 1, whereby the curing of the melamine-containing resin in hot steam is being followed directly by the step of thermal modification of the wood or wood-based material, without prior cooling of the wood or wood-based material to temperatures of below 50° C.

19. The method of claim 1, whereby the step of thermal modification comprises a modification at temperatures of 150° C. to 280° C.

20. The method of claim 1, whereby the wood or wood-based material, before conducting the step of impregnation with the melamine-containing resin and the subsequent step of curing under hot steam conditions at not more than 150° C., more particularly not more than 120° C., has been subjected to a step of thermal modification.

21. The method of claim 1, whereby the step of impregnation comprises that the wood or wood-based material is being impregnated completely with the melamine-containing resin.

22. The method of claim 1, wherein the melamine-containing resin is one of the following: melamine-formaldehyde resin, melamine-urea-formaldehyde resin, melamine-urea-phenol-formaldehyde resin, methanol-etherified melamine-formaldehyde resin.

23. The method of claim 1, wherein the solution with melamine-containing resin for impregnating the wood or wood-based material contains no other treatment agents, no catalyst, no coloring substances and/or no substances relevant to fire protection.

24. The method of claim 1, wherein the wood or wood-based material consists of at least one of the following wood types: pine, Weymouth pine, alder, birch, maple, beech, hornbeam, willow, poplar, Hevea and Bombax species, chestnut ceiba, ramin, sesendok, ilomba, kondroti, eucalyptus, limba, coto, and also the sapwood of all European wood types, more particularly limba (Terminalia superba) or koto (Pterygota ssp.).

25. The method of claim 1, wherein the step of thermal modification comprises at least the step of a high-temperature vacuum treatment.

26. The method of claim 1, wherein the step of impregnation comprises a vacuum pressure impregnation.

27. The method of claim 1, wherein the wood or wood-based material is subjected lastly to the step of moisture conditioning.

28. A thermally modified wood or wood-based material impregnated with melamine resin and cured, obtainable in accordance with any of claims 17 to 27 or claims 32 to 38.

29. The wood or wood-based material of claim 12, wherein the wood or wood-based material exhibits increased strengths and surface hardness and also improved optical properties in comparison to thermally modified wood or wood-based material without melamine resin impregnation treatment.

30. A boat, having a deck and decking, characterized in that the decking is formed of wooden elements of either of claims 28 and 29 and/or having a handrail, characterized in that the handrail is formed of a wood or wood-based material of either of claims 28 and 29.

31. A teak substitute being a thermally modified wood or wood-based material, impregnated with melamine resin and cured, of either of claims 28 to 29.

32. The method of claim 1 whereby the wood or wood-based material is cured in a hot steam atmosphere at not more than 120° C.

33. The method of claim 16 whereby the wood or wood-based material is cured in a hot atmosphere is conducted at a temperature of from 90° C-120° C.

34. The method of claim 3 whereby the thermal modification temperature is from 180° C. to 240° C.

35. The thermally modified wood or wood-based material according to claim 12 comprising limba (Terminalia superba) or koto (Pterygota ssp).

36. The method of claim 4 wherein the thermal modification has been conducted at temperatures of from 160° C. to 280° C.

37. The method of claim 20 wherein the thermal modification has been conducted at temperatures of from 180° C. to 240° C.

38. The method of claim 10, wherein the step of impregnation comprises a vacuum pressure impregnation with a preliminary vacuum phase and/or a high-pressure phase.
